(19) United States
(12) Patent Application Publication
(10) Pub. No.: US 2026/0370542 A1
(43) Pub. Date: Nov. 19, 2026

(54) AUTOMATIC ROOT CAUSE ANALYSIS OF USER LOGS USING A MACHINE LEARNING MODEL

(71) Applicant: Rakuten Symphony, Inc., Tokyo (JP)

(72) Inventor: Prabin Kumar Panda, Bangalore (IN)

(21) Appl. No.: 19/209,089

(22) Filed: May 15, 2025

(51) Int. Cl. H04L 41/0631; H04L 41/069; H04L 41/16; H04W 24/02; H04W 28/02

(52) U.S. Cl. CPC H04L 41/064; H04L 41/069; H04L 41/16; H04W 24/02; H04W 28/0236

(57) ABSTRACT

A system includes a cellular communication network comprising a plurality of distributed units each coupled to one or more radio units configured to send and receive radio signals with respect to a plurality of user equipment (UE). The cellular communication network is configured to receive one or more UE logs from one or more UE of the plurality of UE. The cellular communication network processes time series data from the one or more UE logs using a machine learning model to identify a root cause of one or more network events. The cellular communication network performs an action in response to identifying the root cause of the one or more network events.

The present disclosure relates to performing root cause analysis of user logs using a machine learning model.

### BACKGROUND

The information disclosed in this background section is only for enhancement of understanding of the general background of the disclosure and should not be taken as an acknowledgement or any form of suggestion that this information forms the prior art already known to a person skilled in the art.

In a cellular communication network, user equipment (UE), such as a mobile phone, wirelessly communicates with radio units (RU) of a cellular communication network. The UE is often moving among the RUs, which may result in the UE going out of range of a RU to which the UE is connected or an obstruction blocking transmission of radio signals to and from the UE. High usage of a cellular communication network or equipment failure may also result in disruption of a wireless connection between the UE and at least one RU of the cellular communication network.

### SUMMARY

In one aspect, a system includes a cellular communication network comprising a plurality of distributed units each coupled to one or more radio units configured to send and receive radio signals with respect to a plurality of user equipment (UE). The cellular communication network is configured to receive one or more UE logs from one or more UE of the plurality of UE. The cellular communication network processes time series data from the one or more UE logs using a machine learning model to identify a root cause of one or more network events. The cellular communication network performs an action in response to identifying the root cause of the one or more network events.

In another aspect, a method includes receiving, by a cellular communication network, one or more UE logs from one or more UE in radio communication with the cellular communication network. The cellular communication network processes the time series data from the one or more UE logs using a machine learning model to identify a root cause of one or more network events; and performing, by the cellular communication network, an action in response to identifying the root cause of the one or more network events.

In another aspect, a non-transitory computer-readable medium stores executable code that, when executed in a cellular communication network, causes the cellular communication network to receive, by the cellular communication network, one or more UE logs from one or more UE in radio communication with the cellular communication network. The cellular communication network processes time series data from the one or more UE logs using a machine learning model to identify a root cause of one or more network events. The cellular communication network performs an action in response to identifying the root cause of the one or more network events.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 is a schematic block diagram of a cellular communication network;

FIG. 2 is a process flow diagram of a method for performing root cause analysis with respect to UE logs in accordance with embodiments of the disclosure;

FIG. 3 illustrates a plot of throughput that has been processed in accordance with embodiments of the disclosure; and

FIG. 4 is a schematic block diagram of an example computing device suitable for implementing methods in accordance with embodiments of the disclosure.

### DETAILED DESCRIPTION

The following detailed description of example embodiments refers to the accompanying drawings. The present disclosure provides illustrations and descriptions but is not intended to be exhaustive or to limit the implementations to the precise form disclosed. Modifications and variations are possible in light of the present disclosure or may be acquired from practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

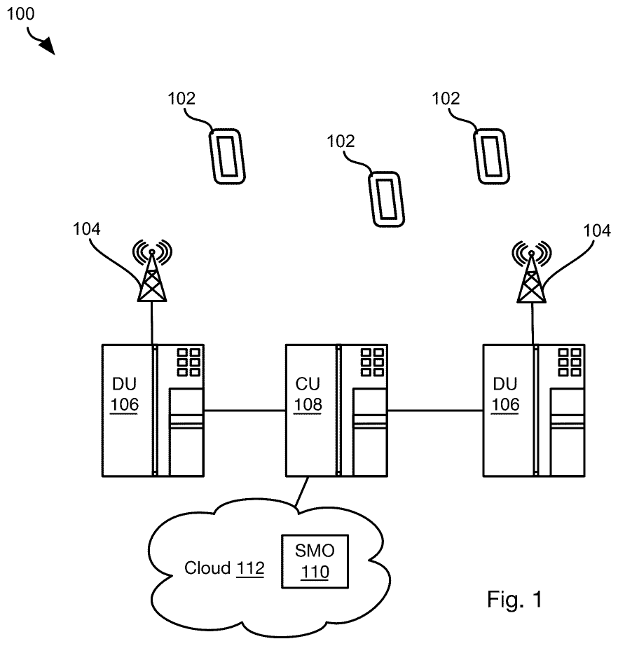

Referring to FIG. 1, in a cellular communication network 100 user equipment (UE) 102 transmits wireless signals to one or radio units (RU) 104 configured to transmit and receive radio signals, such as using an antenna or array of antennas. The data transmitted to the UE 102 and received from the UE 102 as well as managing a logical connection with the UE 102 according to a cellular communication protocol may be managed by a distributed unit (DU) 106 coupled to the RU 104. The DU 106 may implement gNodeB (gNB) in a fifth generation (5G) network.

The DUs 106 may be in communication with a central unit (CU) 108. The CU 108 may perform tasks relating to coordination among DUs 106, such as performing handoffs of a connection to a UE 102 from one DU 106 to a different DU 106.

CUs 108 of the cellular communication network 100 may be in data communication with a service management and orchestration (SMO) functions 110. The SMO functions 110 may implement functionality to monitor and control the function of the DUs 106. The SMO 110 may execute in a cloud 112 or another computing environment.

An operator of a cellular communication network 100 strives to provide an expected quality of service to users each the UE 102. The cellular communication network 100 may therefore collect UE log data from the UE 102, e.g., each UE 102 associated with a customer of the operator. In existing implementations, UE log data is generated and maintained locally at the UE 102. UE log data typically includes events such as radio link failures (RLFs), throughput metrics, and other radio access-related parameters.

The methods disclosed herein may be performed with respect to UEs 102 that are additionally configured to collect UE log data that includes per-slot level log data and transmit such UE log data to the cellular communication network 100 in response to a specific request from a network entity, such as a DU 106, CU 108, or other core network function. The request may be triggered based on detection of anomalous behavior, degraded quality of service, or upon initiation of a diagnostic session. The per-slot level log data may include timestamped measurements, transmission parameters, hybrid automatic repeat request (HARQ) statuses, radio link control (RLC) buffer conditions, or other metrics collected by the UE 102. By enabling on-demand transfer of such fine-grained data, the cellular communication network 100 may perform targeted root cause analysis and troubleshooting of UE-reported or network-observed issues, such as according to the methods disclosed hereinbelow. This selective reporting mechanism reduces persistent signaling overhead and conserves UE-side power consumption. The methods described hereinbelow may be used according to any current or future cellular communication protocol, such as 5G protocol or the upcoming 6G protocol.

The methods disclosed herein solve a number of technical limitations of prior approaches to processing UE logs. For example, prior approaches of processing UE logs (e.g., RLF reports) provide only high-level failure cause types. Using the approach described herein, transient and complex issues that occur at the per slot (e.g., time window allocated for a UE 102 to send or receive data) level may be detected and evaluated.

Prior methods rely heavily on manual analysis by domain experts, which is time-consuming, error-prone, and not scalable for large-scale networks. Using the approach described herein, processing is automated and enables the cause of connectivity issues to be identified in an efficient and cost-effective manner. Likewise, the more granular information available using the approach described herein enables efficient and cost-effective resolution of network issues and improving performance of the cellular communication network 100.

Prior approaches include manually evaluating RLFs of UE logs. The approach described herein, provides an automated holistic view of network performance issues, including correlation among data for multiple layers of data (e.g., physical layer, medium access code (MAC) layer, and radio link control (RLC) layer), packet data convergence protocol (PDCP) layer, a service data adaptation protocol (SDAP) layer, a radio resource control (RRC) layer, or a non-access stratum (NAS) layer).

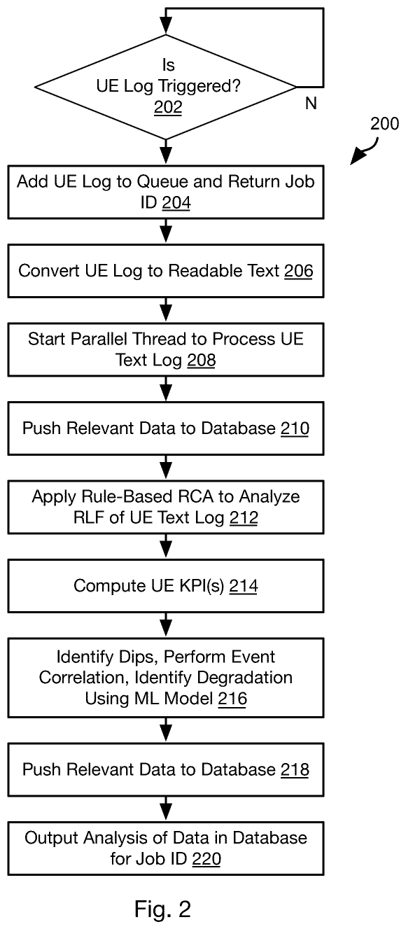

FIG. 2 illustrates a method 200 for processing UE logs. The method 200 may be performed by the DU 106 to which the UE 102 transmitted a UE log, the CU 108 to which such a DU 106 transmitted the UE log, or the SMO functions 110 to which the CU 108 transmitted the UE log, or by some other host (e.g., cloud host) to which the UE log is uploaded for remote processing. The UE log may be transmitted by the UE 102 during production use or during a testing phase of a portion of the cellular communication network 100, such as while performing drive testing, such as FTP DL/Speedtest.

The method 200 may include evaluating, at step 202, whether a UE log is triggered. For example, step 202 may include evaluating whether a UE log has been received from a UE 102. Step 202 may further include evaluating whether a received UE log meets some condition, such as reporting a RLF or other condition. The UE log may include data, or a characterization of data, collected over a period of time. In some embodiments, the UE log is a QUALCOM extensible Diagnostic Monitor (QXDM) log or other type of log.

If a UE log is not received, or a UE log meeting a condition is not found to have been received, step 202 may be repeated, such as after a waiting period. If a UE log, or a UE log meeting a condition, was received, some or all of the remaining steps of the method 200 may be performed.

UE logs may be received from many UEs 102 such that the UE log is added to a queue at step 204. UE logs may be retrieved from the queue, such as in order of receipt, and processed according to subsequently described steps of the method 200. UE logs may be processed from the queue by multiple threads of execution or computing nodes. A job identifier may also be associated with the UE log and returned at step 204, such as to the UE 102 itself, the SMO 110 that is monitoring the UE 102, or other process. The UE log and data generated based on the UE log according to the method 200 may be stored in association with the job identifier.

The UE log may be processed at step 206 to convert the UE log to readable text at step 206. Step 206 may be performed using various existing software modules, such as any tool for parsing files in combination with logic according to the format of the UE log for extracting data from the UE log. For example, step 206 may include using a tool such as QCAT.

The method 200 may include starting, at step 208, a parallel thread to process the UE text log, i.e., the result of step 206. Step 208 may be performed in parallel with one or more of the subsequently described steps of the method 200. However, in other embodiments, the steps of the method 200 are performed sequentially. The results of step 208 may be pushed to a database at step 210. The result of step 208 may be a subset of data in the UE text log that is relevant, e.g., that is deemed relevant to performing root cause analysis of an RLF, handover failure, packet drop, degradation in quality of service, or other issue affecting the UE 102 that generated the UE log. For example, the data extracted at step 208 and pushed to the database at step 210 may include signal strength data, RLF event records, protocol layer metrics, or the like.

The database may be a structured database, such as a structured query language (SQL) database. The data pushed to the database at step 210 may be associated with the job identifier and may likewise include an identifier of the UE 102 that generated the UE log and/or an identifier of the DU that received the UE log.

The method 200 may include applying, at step 212, rule-based root cause analysis (RCA) to analyze RLFs indicated in the UE text log. In particular, the UE text log may include highly granular data, e.g., for specific slots, that may be processed according to rules to perform RCA. For example, step 212 may include applying layer-wise rule-based logic to text in the UE text log to perform RCA relative to an RLF indicated in the UE text log. The layers processed may include the physical, MAC, RLC, and possibly higher layer data. The processing of step 212 may include identifying applying decision rules to classify the UE text log as indicating one of a plurality of possible failure scenarios. Step 212 may include processing multiple UE text logs to determine the root cause of network events reflected in the UE text logs, e.g., identify a root cause of a plurality of network events contained in UE text logs from a plurality of UE 102.

The method 200 may include computing, at step 214, key performance indicators (KPI) according to the UE text log or a plurality of UE text logs. A KPI may include any KPI known in the field of cellular communication, such as received signal strength indicator (RSSI), uplink throughput, downlink throughput, or the like.

The method 200 may include processing the UE log and/or UE text log, or set of UE logs and/or UE text logs, with a machine learning model at step 216. The processing of step 216 may include processing time series data, e.g., measured values of a parameter over time. For example, the time series data may include measured values for downlink throughput, received signal strength, uplink throughput, carrier frequency, or any other parameter. The time series data may be in the form of samples and corresponding time stamps.

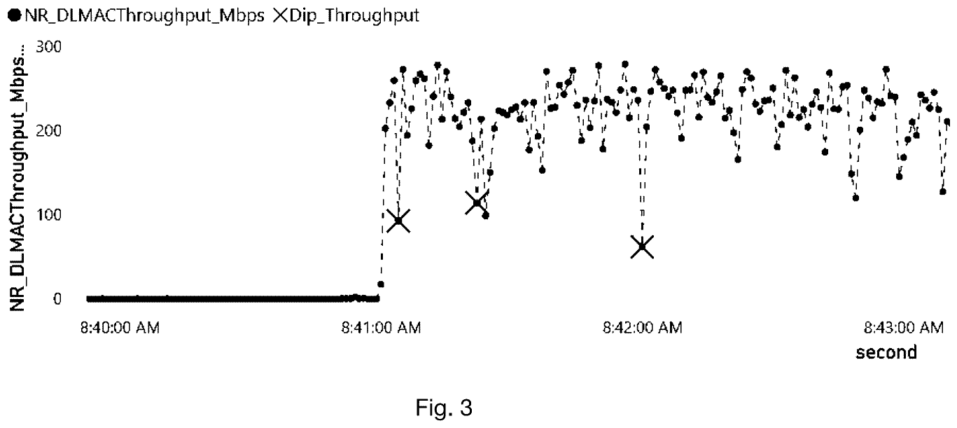

Referring to FIG. 3, in one example, step 216 may include identifying dips (e.g., in downlink throughput), performing event correlation, and/or identifying degradation in a quality of service (QoS) received by the UE 102. For example, FIG. 3 illustrates a plot of downlink throughput (e.g., in megabits per second (Mbps)) of a UE 102. As is readily apparent, the throughput varies considerably over time, including many dips in throughput. Accordingly, it may be difficult to identify a throughput dip that is significant. As used herein, a “significant” dip may be understood as a dip that corresponds to a network event such as a RLF, handover failure, packet drop, degradation in quality of service, or the like.

A machine learning model may be trained to process the throughput data and possibly other data to identify significant dips. The machine learning model may be a random forest model, logistic regression model, multiple linear regression model, long shirt term memory (LSTM) model, neural network, deep neural network, convolution neural network, multiple linear regression model, random sample consensus regression model, multiple polynomial regression model, support vector regression model, Bayesian neural network, genetic algorithm, or any other type of machine learning model.

The machine learning model may be trained with training data entries that each include, as an input, data from one or more UE logs (e.g., downlink throughput time series data) and possibly other data that may be relevant to identifying a dip, such as record of a RLF or other network event (including a time stamp of the RLF or other network event) for one or more UE 102 that generated the one or more UE logs. The input may include other time series data from each UE log (e.g., uplink throughput data, data describing a channel (received signal strength, carrier frequency, or the like), or other data from the UE log and/or UE text log. Each training data entry may include, as a desired output, information such as time stamps of samples in time series data indicating significant throughput dips (e.g., the samples marked with X symbols in FIG. 3) one or more correlations between data from different UE logs or data from the same UE log and network events. For example, the output may include a correlation between a significant throughput dip and one or more network events represented in the one or more UE logs.

The desired output of each training data entry may be obtained using various approaches. A test bench may be created using a DU 106 and RU 104 that are caused to create various error conditions relative to a UE 102 such that significant throughput dips and correlations to the error conditions are known and may be used as the desired output for inputs obtained from UE logs of the UE 102 while the error conditions exist. UE error logs and known significant dips and possibly correlations to error conditions for use in training data entries may also be generated using simulations of behavior of a DU 106, RU 104, and UE 102 for various scenarios (distances, obstructions, movement of the UE 102, etc.). Data for training data entries may be obtained by enhanced monitoring of a DU 106 and RU 104 during communication with a UE 102, such as during drive testing. The enhanced monitoring may provide ground truth regarding the timestamps of significant dips and correlations between significant dips and network events.

The machine learning model may be trained by, for each training data entry, processing the input of the training data entry using the machine learning model to obtain an inference. A training algorithm may evaluate the inference with respect to the desired output of the training data entry, such as using a loss function, and update the machine learning model according to the evaluation.

Following training, the machine learning model provides a data-driven approach for processing UE logs. Inasmuch as the UE logs are rich in data, including time series data at a slot level of detail, a more accurate perspective on the operation of the cellular communication network 100. A different machine learning model as described above may be trained for each type of network of a plurality of different network types, such as 4G, 5G, 6G, etc. Likewise, a machine learning model may be trained for a specific use case of a given network type, e.g., for specific types of network events.

The method 200 may include pushing relevant data to the database at step 218. As for step 210, the data pushed to the database may be associated with the job identifier. The data pushed at step 218 may include the result of RCA at step 212, one or more KPIs at step 214, and dips, correlations, and/or degradation identified at step 216.

The method 200 may include outputting an analysis of data in the database for the job identifier at step 220. Step 220 may include using a data visualization tool, such as POWER BI to generate a graphical representation and/or statistical characterization of the data in the database for the job identifier at step 220. Step 220 may include generating analysis of data in the database for multiple job identifiers, e.g., multiple UE logs of the same UE 102 or multiple UEs 102.

The graphical representation of data analyzed at step 220 may include a user-friendly dashboard that allows end users to explore network KPIs, network events (RLF, degradation, other failures), event correlations, and other information indicated by the data in the database for one or more job identifiers. The graphical representation may include customizable filters, drill-down and graph options, automated report generation, or other tools to facilitate troubleshooting.

The data stored in database for a job identifier may be retained and data stored in the database for a plurality of job identifiers over time may be used to perform historical analysis of UE logs. The results of such analysis may be presented in a graphical representation according to any of the examples described above. Historical analysis of UE logs may be used to perform pre and post analysis of changes to a cellular communication network 100. For example, the UE logs may be used to evaluate changes to the cellular communication network 100 (e.g., modifying equipment or adding new equipment, software builds and/or features).

Step 220 may include recommending, and possibly automatically implementing, actions to improve network function, guide further trouble shooting, or directly resolve an issue indicated by the UE log data analyzed according to the method 200. For example, step 220 may include automatically adjusting operation of a DU 106 to address a RLF, handover failure, packet drop, a degradation in quality of service, or the like. For example, a DU 106 may be modified to reduce a number of connected UE 102, perform handovers more frequently to avoid handover failures, or perform other actions.

The method 200 provides many benefits. First, the method 200 automates a traditionally manual process of UE log analysis, which reduces the need for domain experts to perform repetitive tasks. The used of a machine learning model to analyze the time series data significantly reduces the time required to analyze UE logs and identify root causes, enabling faster resolution of network issues. The per-slot-level analysis and multi-layer correlation provide deeper insights into network performance, leading to more effective improvements.

The automated analysis of UE logs reduces the reliance on manual effort and therefore lowers operational costs associated with test driving and troubleshooting. The method 200 can be scaled to handle large-scale networks and massive volumes of UE logs, making the method 200 suitable for modern 5G and future 6G networks.

In a first example use case of the method 200, a UE 102 reports an RLF, such as in a test bench. The UE log reporting the RLF may include the following information “Bug BUG_ID-[NSA] [FR1] [BUILD_ID] Getting SCG failure due to rlc-MaxNumRetx during longrun with bad channel condition.” The result of the method 200 may be a report indicating the following information:

2024 Mar 19 06:51:08.271000 ,rlc-MaxNumRetx
RLF for UL RLC SN:48800
UE RNTI : 7
Expected RLC RETransmission not observed in the log!
UE declared RLF to mitigate high thermal !
Outcome: Users whose UE are randomly declaring RLF, can now
understand the cause of the RLF and will take action accordingly.

In another example use case, a UE 102 reports an RLF, such as in a test bench. The following information is reported in a UE log corresponding to the RLF:
Bug BUG_ID-[Lab_Name] [NSA] [BUILD_ID]: SCG Failure due to RLC Re-Tx Max with UL Data

The result of the method 200 may include the following information:

```
1980 Feb 17 20:35:31.860 [96] 0xB0C0 LTE RRC OTA Packet -- UL_DCCH /
Extension_c2_scgFailureInformationNR_r15
    failureType-r15 rlc-MaxNumRetx,
  t-PollRetransmit ms45,
  Last DL Status PDU for SN: 5159
  ReTX SN: 35919
DL status PDU wasn't received from gNB and hence UE declared RLF post ReTX max due t-
pollRetransmit timer expiry
Outcome: For SRS, DL RAT0 scheduling type is used. In this type for lower DL RB allocation
packets are dropped. This was leading to DL Status PDU packets getting dropped when only UL
was ongoing. Post this fix, RLF wasn't observed.
```

In a third example use case, a PSDCH discard is observed in a test bench and the following information is reported in a corresponding UE log:
Scenario3: PSDCH discard observed in lab setup
BUG_ID-[Lab_Name] [SA] [Functional] [BUILD_ID]: High number of PDSCH discard seen for signaling messages in initial SA attach at good channel condition

The result of the method 200 may include the following information:

The following table:

| Next State | ReTx: | ReTx: | |
|---|---|---|---|
| UL_HARQ_SR_CSI | Discard | Fail | Pass |
| PUCCH_1_0_1 | 1.0 | NaN | 13.0 |
| PUCCH_2_0_2 | NaN | NaN | 4.0 |
| PUCCH_3_0_3 | NaN | NaN | 8.0 |
| PUCCH_3_0_3 | NaN | NaN | 3.0 |
| PUCCH_4_0_14 | NaN | NaN | 3635.0 |
| PUCCH_4_0_16 | NaN | 1.0 | 1259.0 |
| PUCCH_4_0_4 | NaN | 9.0 | 77700.0 |
| PUSCH_1_0 | 3.0 | NaN | 3.0 |
| PUSCH_2_0 | NaN | NaN | 16.0 |
| PUSCH_3_0 | NaN | NaN | 3.0 |
| PUSCH_4_0 | NaN | 5.0 | 99476.0 |
| PUSCH_4_10 | NaN | NaN | 966.0 |
| PUSCH_4_12 | NaN | 1.0 | 4791.0 |

Outcome: Using above analysis, it could be observed that discard in observed in only one type of UL for ACK feedback. (PUCCH_1_0_1 and PUSCH_1_0→Number of HARQ bit 1) On further analysis, it is observed that UE is sending one bit HARQ ACK instead of expected two bit HARQ ACK which is leading to DTX on gNB side.

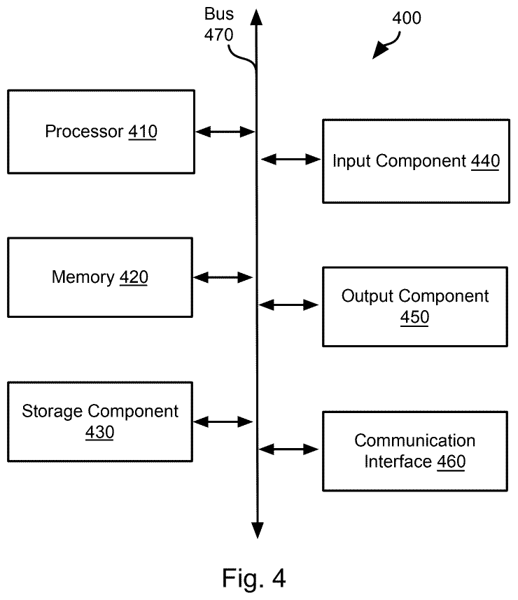

FIG. 4 illustrates an embodiment of a computing device 400 that may be used to implement some or all of the components of the cellular communication network 100. As shown in FIG. 4, the computing device 400 includes a processor 410, a memory 420, a storage component 430, an input component 440, an output component 450, a communication interface 460, and a bus 470.

The processor 410, as used herein, means any type of computational circuit that may comprise hardware elements and software elements. The processor 410 may be embodied as a multi-core processor, a single core processor, or a combination of one or more multi-core processors and/or one or more single core processors, a distributed processing system, or the like. The processor 410 may be a Central Processing Unit (CPU), a graphics processing unit (GPU), an accelerated processing unit (APU), an application-specific integrated circuit (ASIC), or another type of processing component.

Memory 420 includes a non-transitory computer readable medium. Memory 420 includes a random-access memory (RAM), a read only memory (ROM), and/or another type of dynamic or static storage device (e.g., a flash memory, a magnetic memory, and/or an optical memory) that stores information and/or instructions for use by processor 410. The memory 420 comprises machine-readable instructions which are executable by the processor 410. These machine-readable instructions when executed by the processor 410 cause the processor 410 to perform one or more method steps of an embodiment described above.

Storage component 430 stores information and/or software related to the operation and use of the device 400. For example, storage component 430 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 440 is configured to receive information, such as user input. For example, the input component 440 may include, but not be limited to, a touch screen display, a keyboard, a keypad, a mouse, a button, a switch, and/or a microphone. Additionally, or alternatively, the input component 440 may include a sensor for sensing information (e.g., a global positioning system (GPS), an accelerometer, a gyroscope, and/or an actuator).

Output component 450 is configured to provide output information from the device 400. For example, the output component 450 may be, but not limited to, a display, a speaker, instructions to an external device, and/or one or more light-emitting diodes (LEDs).

Communication interface 460 is an interface that provides a communication connection to other devices, such as external devices and internal devices. The connection by the communication interface 460 can be a wired connection, a wireless connection, or a combination of wired and wireless connections, and can be a direct connection or an indirect connection via a communication network that exists between the device 400 and other devices. In other words, the standard of the communication interface 460 is not limited.

The bus 470 acts as an interconnect between the processor 410, the memory 420, the storage component 430, the input component 440, the output component 450, and the communication interface 460 of the device 400. The bus 470 may include a wired interconnection or a wireless interconnection.

The number and arrangement of components shown in FIG. 4 are provided as an example. In practice, device 400 may include additional components, fewer components, different components, or differently arranged components than those shown in FIG. 4. Additionally, or alternatively, a set of components (e.g., one or more components) of device 400 may perform one or more functions described as being performed by another set of components of device 400. Further, one or more method steps described in any of the embodiments may be performed utilizing a plurality of devices 400 in communication with one another.

In a first example embodiment, a system includes: a cellular communication network comprising a plurality of distributed units each coupled to one or more radio units configured to send and receive radio signals with respect to a plurality of user equipment (UE); wherein the cellular communication network is configured to: receive one or more UE logs from one or more UE of the plurality of UE; process time series data from the one or more UE logs using a machine learning model to identify a root cause of one or more network events; and perform an action in response to identifying the root cause of the one or more network events.

In a second example embodiment of the first example embodiment, the machine learning model is a random forest model.

In a third example embodiment of the first example embodiment, the one or more network events include at least one of a radio link failure, a handover failure, or a packet drop.

In a fourth example embodiment of the first example embodiment, the time series data is slot-level throughput data.

In a fifth example embodiment of the fourth example embodiment, the machine learning model is trained to identify significant dips in the throughput data, the significant dips corresponding to the one or more network events.

In a sixth example embodiment of the fourth example embodiment, the throughput data is downlink throughput data.

In a seventh example embodiment of the first example embodiment, the machine learning model is further trained to perform correlations of the time series data with respect to other data in the one or more UE logs.

In an eighth example embodiment of the first example embodiment, the cellular communication network is further configured to perform rule-based root cause analysis with respect to the one or more UE logs by applying layer-wise rule-based logic with respect to a plurality of layers.

In a ninth example embodiment of the eighth example embodiment, the plurality of layers include two or more of a physical layer, medium access code (MAC) layer, radio link control (RLC), packet data convergence protocol (PDCP) layer, a service data adaptation protocol (SDAP) layer, a radio resource control (RRC) layer, or a non-access stratum (NAS) layer.

In a tenth example embodiment of the first example embodiment, the action is at least one of modification of the cellular communication network or outputting a graphical representation of the root cause.

In an eleventh example embodiment, a method includes: receiving, by a cellular communication network, one or more UE logs from one or more UE in radio communication with the cellular communication network; processing, by the cellular communication network, time series data from the one or more UE logs using a machine learning model to identify a root cause of one or more network events; and performing, by the cellular communication network, an action in response to identifying the root cause of the one or more network events.

In a twelfth example embodiment of the eleventh example embodiment, the machine learning model is a random forest model.

In a thirteenth example embodiment of the eleventh example embodiment, the one or more network events include at least one of radio link failure, handover failure, or packet drop.

In a fourteenth example embodiment of the eleventh example embodiment, the time series data is slot-level downlink throughput data.

In a fifteenth example embodiment of the fourteenth example embodiment, the method further includes identifying, by the machine learning model, significant dips in the throughput data, the significant dips corresponding to the one or more network events.

In a sixteenth example embodiment of the fourteenth example embodiment, the throughput data is downlink throughput data.

In a seventeenth example embodiment of the eleventh example embodiment, the method further includes performing, by the machine learning model, correlation of the time series data with respect to other data in the one or more UE logs.

In an eighteenth example embodiment of the eleventh example embodiment, the method further includes performing, by the cellular communication network, rule-based root cause analysis with respect to the one or more UE logs by applying layer-wise rule-based logic with respect to a plurality of layers.

In a nineteenth example embodiment of the eighteenth example embodiment, the plurality of layers include two or more of a physical layer, medium access code (MAC) layer, radio link control (RLC), packet data convergence protocol (PDCP) layer, a service data adaptation protocol (SDAP) layer, a radio resource control (RRC) layer, or a non-access stratum (NAS) layer.

In a twentieth example embodiment, a non-transitory computer-readable medium storing executable code that, when executed in a cellular communication network, causes the cellular communication network to: receive, by the cellular communication network, one or more UE logs from one or more UE in radio communication with the cellular communication network; process, by the cellular communication network, time series data from the one or more UE logs using a machine learning model to identify a root cause of one or more network events; and perform, by the cellular communication network, an action in response to identifying the root cause of the one or more network events.

1. A system comprising:
a cellular communication network comprising a plurality of distributed units each coupled to one or more radio units configured to send and receive radio signals with respect to a plurality of user equipment (UE);
wherein the cellular communication network is configured to:
receive one or more UE logs from one or more UE of the plurality of UE;
process time series data from the one or more UE logs using a machine learning model to identify a root cause of one or more network events; and
perform an action in response to identifying the root cause of the one or more network events.

2. The system of claim 1, wherein the machine learning model is a random forest model.

3. The system of claim 1, wherein the one or more network events include at least one of a radio link failure, a handover failure, or a packet drop.

4. The system of claim 1, wherein the time series data is slot-level throughput data.

5. The system of claim 4, wherein the machine learning model is trained to identify significant dips in the throughput data, the significant dips corresponding to the one or more network events.

6. The system of claim 4, wherein the throughput data is downlink throughput data.

7. The system of claim 1, wherein the machine learning model is further trained to perform correlations of the time series data with respect to other data in the one or more UE logs.

8. The system of claim 1, wherein the cellular communication network is further configured to perform rule-based root cause analysis with respect to the one or more UE logs by applying layer-wise rule-based logic with respect to a plurality of layers.

9. The system of claim 8, wherein the plurality of layers include two or more of a physical layer, medium access code (MAC) layer, radio link control (RLC), packet data convergence protocol (PDCP) layer, a service data adaptation protocol (SDAP) layer, a radio resource control (RRC) layer, or a non-access stratum (NAS) layer.

10. The system of claim 1, wherein the action is at least one of modification of the cellular communication network or outputting a graphical representation of the root cause.

11. A method comprising:
receiving, by a cellular communication network, one or more UE logs from one or more UE in radio communication with the cellular communication network;
processing, by the cellular communication network, time series data from the one or more UE logs using a machine learning model to identify a root cause of one or more network events; and
performing, by the cellular communication network, an action in response to identifying the root cause of the one or more network events.

12. The method of claim 11, wherein the machine learning model is a random forest model.

13. The method of claim 11, wherein the one or more network events include at least one of radio link failure, handover failure, or packet drop.

14. The method of claim 11, wherein the time series data is slot-level downlink throughput data.

15. The method of claim 14, further comprising identifying, by the machine learning model, significant dips in the throughput data, the significant dips corresponding to the one or more network events.

16. The method of claim 14, wherein the throughput data is downlink throughput data.

17. The method of claim 11, further comprising performing, by the machine learning model, correlation of the time series data with respect to other data in the one or more UE logs.

18. The method of claim 11, further comprising performing, by the cellular communication network, rule-based root cause analysis with respect to the one or more UE logs by applying layer-wise rule-based logic with respect to a plurality of layers.

19. The method of claim 18, wherein the plurality of layers include two or more of a physical layer, medium access code (MAC) layer, radio link control (RLC), packet data convergence protocol (PDCP) layer, a service data adaptation protocol (SDAP) layer, a radio resource control (RRC) layer, or a non-access stratum (NAS) layer.

20. A non-transitory computer-readable medium storing executable code that, when executed in a cellular communication network, causes the cellular communication network to:
receive, by the cellular communication network, one or more UE logs from one or more UE in radio communication with the cellular communication network;
process, by the cellular communication network, time series data from the one or more UE logs using a machine learning model to identify a root cause of one or more network events; and
perform, by the cellular communication network, an action in response to identifying the root cause of the one or more network events.
